(19) United States
(12) Patent Application Publication
(10) Pub. No.: US 2008/0214312 A1
(43) Pub. Date: Sep. 4, 2008

(54) Security System For Authenticating Gaming Chips

(75) Inventor: Christian Richard, Dorval (CA)

Correspondence Address: BOND, SCHOENECK & KING, PLLC, 10 BROWN ROAD, SUITE 201, ITHACA, NY, 14850-1248, US

(73) Assignee: Ubitrak Inc., Montreal, QC (CA)

(21) Appl. No.: 11/574,173

(22) PCT Filed: Sep. 30, 2005
(86) PCT No.: PCT/CA05/01519

§ 371 Date: Nov. 7, 2007

Related U.S. Application Data
(60) Provisional application No. 60/614,957, filed on Oct. 1, 2004.

(51) Int. Cl. A63F 9/24; G06F 19/00

(52) U.S. Cl. 463/47; 235/385

(57) ABSTRACT

A system for authenticating RFID-capable gaming chips in a casino. The system includes at least one security server, at least one secure network, a casino management system and a plurality of magnetic couplers distributed within the casino. The gaming chips are adapted to provide a response to a challenge issued by the magnetic couplers when the chips are located in the vicinity of the magnetic couplers. The chip is authenticated when the response matches a computed response by the server. Preferably, the authentication information is loaded into the chip prior to the chip being used in the casino. The response preferably takes the form of a one time password, so that when the password list is depleted within the chip, the chip must be re-commissioned.

### TECHNICAL FIELD

This invention relates to the use of cryptographic algorithms for the authentication of RFID capable devices used within casino environment and, more specifically to the cryptographic authentication of RFID capable gaming chips.

### BACKGROUND OF THE INVENTION

Among all the approaches and measures that have been presented in the past years as concrete solutions for deterring counterfeiting and prevent unlawful and fraudulent wins within casinos, RFID-based solutions have received the greatest attention from both the industry and research communities.

Radio Frequency Identification technology is currently widely used in multiple industry sectors including manufacturing, transportation, postal tracking, medical, pharmaceutical and highway toll management. A typical RFID system configuration comprises an RFID transponder usually located on the object to be identified, an RFID interrogator or reader and a computing device. The interrogator is typically made of a radio frequency module, a control unit and a coupling element that transfers a sufficient amount of energy to the transponder. The transponder actually carries the data and it normally consists of a coupling element and an electronic microchip.

Several patents pertaining to RFID-based casino gaming chip monitoring for anti-counterfeiting purposes and player tracking have been issued. U.S. Pat. No. 5,166,502 (Rendelman et al.) shows a construction of radio frequency transponder embedded in a gaming chip. The transponder is tagged with information concerning the chip such as chip identity and value. The particular transponder described in that patent was specifically designed to work with slot machines. However, extending the application field of afore mentioned chip to gaming tables such as black jack tables or baccarat was not considered in this patent, and it would not work because the information contained in the chip cannot be changed.

In U.S. Pat. Nos. 5,651,548 and 5,735,742, French et al. present other RFID-based apparatus and methods of tracking gaming chip movement within casinos. These methods address the flaws of the previous patent by allowing chip tracking at various places within the casino including gaming tables and chip trays. Possibility of reading and writing in the integrated circuit containing token information is also explored. However, the solution proposed by French et al. will not prevent malicious players from impersonating a genuine RFID capable gaming chip. In fact, the method described by French et al. does not address security issues at all; hence, intercepting the communication between the interrogating device and the gaming chip and subsequently resending the intercepted serial number through the means of an easily constructed mini-sender is made quite easy. This and other powerful attacks on RFID capable devices have proven that relying solely on the uniqueness of the chip serial number is not enough to ensure security and thus prevent chip replication.

Some security approaches devised in the past for chip memory content protection were essentially limited to string of security bits which could be irreversibly toggled by the RFID device. If this approach is successful in preventing writing into a specific memory location, it would not prevent reading from that memory location.

### SUMMARY OF THE INVENTION

In summary, the present invention discloses system and methods that prevent gaming chip counterfeiting, RFID capable gaming chip tampering and RFID capable gaming chip impersonation. Further, the present invention enforces RFID capable gaming chips validity assessment at gaming tables, cashier stations or at any other location within the casino where assessing the validity of the gaming chip is required.

Thus, it is an object of the present invention is to provide a security system for casino gaming chips authentication. In accordance with this object, there is provided a system for authenticating RFID-capable gaming chips in a casino, said system comprising at least one security server, at least one secure network, a casino management system and a plurality of magnetic couplers distributed within the casino, wherein said gaming chips are adapted to provide a response to a challenge issued by said magnetic couplers when said chips are located in the vicinity of said magnetic couplers, whereby said chip is authenticated when said response matches a computed response by said server.

In accordance with another aspect of the invention, there is provided a method for authenticating RFID-capable gaming chips within a casino, comprising the steps of:
(a) commissioning said chips at a commissioning station, including loading into said chip authentication information;
(b) providing a plurality of magnetic couplers distributed in said casino;
(c) issuing a challenge from said magnetic couplers to said chips when said chips are located in the vicinity of said magnetic couplers;
(d) receiving a response from said chip;
(e) comparing said response to a computed response; and
(f) authenticating said chip when said response matches said computed response.

In accordance with yet another aspect of the invention, there is provided a method for authenticating an RFID reader to a gaming chip within the casino comprising:
the gaming chip issuing a challenge to the RFID reader;
the gaming chip receiving a response from the RFID reader;
comparing said response to a computed response; and
authenticating the reader when said response matches said computed response.

Using such authentication it can be guaranteed that a gaming chip used within the casino will partly or entirely disclose the security critical information to an interrogating device only after successful assessment that the interrogating device is indeed legitimately empowered to access this security information. Similarly, using such authentication will help assessing that any RFID capable gaming chip used at a gaming table or at any other location within the casino actually contains legitimate security information introduced into the gaming chip memory during commissioning or at any other time by legitimate staff within the casino. This means that any tampering with the gaming chip memory content will be detected. A gaming chip authentication system as disclosed in the invention will impede malicious players from dissimulating fake gaming chips—that is, those gaming chips with a valid serial number but invalid security code or temporarily stolen security code—among valid gaming chips.

Another object of the present invention is to provide a gaming chip authentication security system that uses a set of secrets whereby each secret out of the set can be used only a predefined number of times. This may include for example using the secret only once. In this case the secret is considered to be one-time password and the term one-time password will be used for this type of secrets interchangeably.

Another object of the invention is to describe a method for changing the authentication secret on a regular basis following a predefined time schedule specified by legitimate casino staff.

The details of one or more embodiments of the invention are set forth in the accompanying drawings and the description below.

### BRIEF DESCRIPTION OF THE DRAWINGS

These and other objects and advantages of the invention will become apparent upon reading the detailed description and upon referring to the drawings in which:

FIG. 1 is an overall view of a security system for gaming chip authentication as disclosed in the current invention.

FIG. 2 is a schematic view of a gaming table with embedded magnetic couplers and communication channel between the table and the central server.

FIGS. 3A and 3B are transactional views of one embodiment of the methods described in this invention.

FIG. 4 is a functional view of the information exchange that occurs between the reader and the chip.

FIGS. 5A and 5B are transactional views of another embodiment of the methods described in this invention.

FIGS. 6A and 6B are transactional views of yet another embodiment of the methods described in this invention.

### DESCRIPTION OF PREFERRED EMBODIMENTS OF THE INVENTION

Embodiments of the security system for gaming chip authentication used in casino to ensure that the chip circulating within the casino and used at the gaming tables are genuine will typically encompass RFID capable gaming tables as described in International application no. PCT/CA2005/001338 filed on Sep. 1, 2005 by the Applicant, which is hereby incorporated by reference.

The embodiments of the security system for gaming chip authentication rely on the existence of a data network within the casino to ensure that legitimate casino staff has properly commissioned the chip used within the casino. It assumed that the network is secure and data traveling though the network from one node to another suffers no additional delay except the propagation time. The embodiments of a system for gaming chip authentication as disclosed in the present invention do not rely on any specific or on any proprietary encryption algorithm to ensure that no security critical information contained within the chip memory has been modified by any entity external to the casino operating staff. This means that any standard asymmetric key encryption algorithm such as RSA or ECC or any standard symmetric key encryption such as DES or AES could be used interchangeably as long they offer the same level of bit security. However, a low footprint encryption algorithm will be preferably used since it will significantly alleviate the network traffic. The embodiments of a system for gaming chip authentication as disclosed in the present invention do not rely on any specific or on any proprietary RFID communication protocol or any RFID frequency. Hence any RFID integrated circuits such as those available off-the-shelves from integrated circuit suppliers such as EM-Microelectronic, Philips Semiconductors, Texas Instruments could be used interchangeably in these embodiments.

In one embodiment of the invention, a gaming table equipped with an RFID reader and interrogation zones communicates in a secure way with a security server in order to fetch gaming chip authenticating information. Such information is then stored temporarily in the reader to speed up communication between the reader and the gaming chips. This temporarily stored information could possibly be used to successfully authenticate gaming chips even in the event of a complete network collapse. Authentication is done following a challenge response protocol whereby a digital signature is used to ensure the integrity of the messages sent by the parts intervening in the protocol

In another embodiment of the invention, the reader is allowed to process gaming chip-authenticating information but the reader is not allowed to store this information. This significantly reduces the amount of memory required at the reader side. But at the same time this requires careful network design since the traffic generated within the network could easily become overwhelming and could lead to a network collapse if no special care is taken.

In another embodiment of the invention, the gaming chip, in this document also subsequently called the “tag”, is assumed to encompass a minimal cryptographic device beside a random number generator. The cryptographic device would preferably be of symmetric key type since these are easier to implement and require less area on the integrated circuit of the tag.

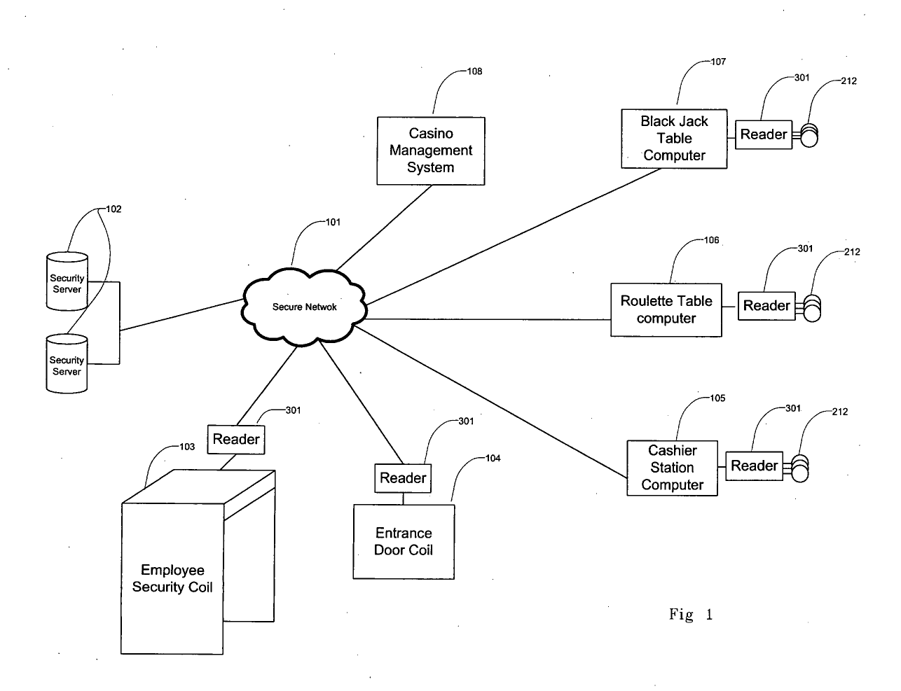

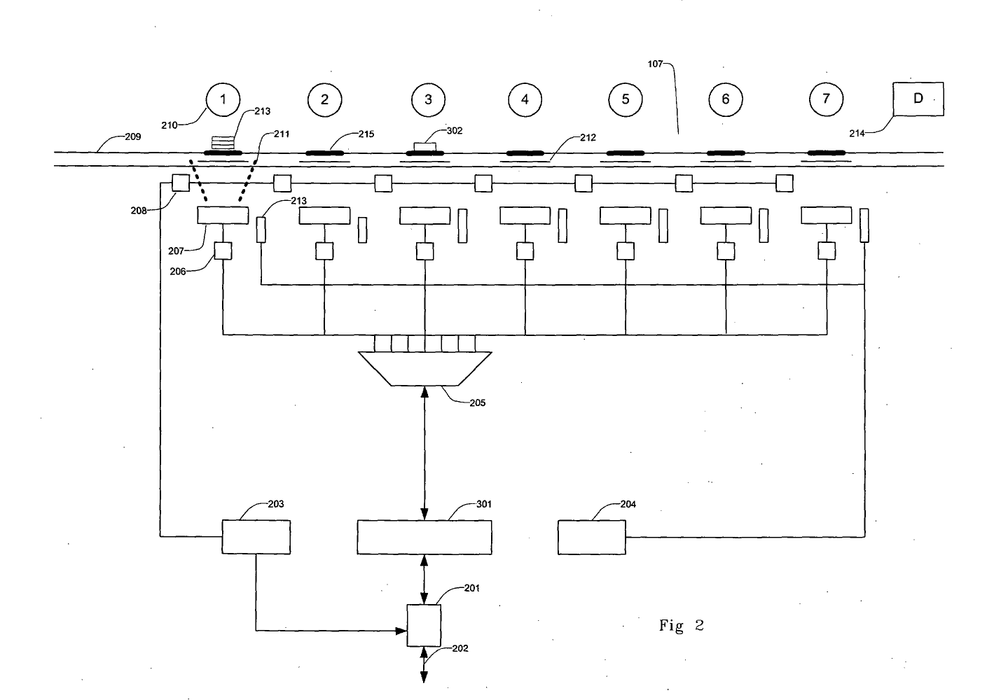

Referring to FIGS. 1 and 2, a security system for authenticating gaming chips 214 according to the present invention has a chip placement area 215 located within the casino preferably on gaming tables 209 (Black Jack table, Roulette table, etc.), a plurality of magnetic couplers 212 together with a plurality of readers 301 and a plurality of multiplexer for chip reading and writing, a secure network 101 together with a security server 102 and a casino management system 108.

Each gaming chip 302 has a memory 407 to store the information received from the security server via the reader 301. Upon arrival at the casino, or at any other time as the case may be, the gaming chips are commissioned. This means that the gaming chips are registered in the casino database. The words gaming chip and tag will be used in the remaining part of this document interchangeably.

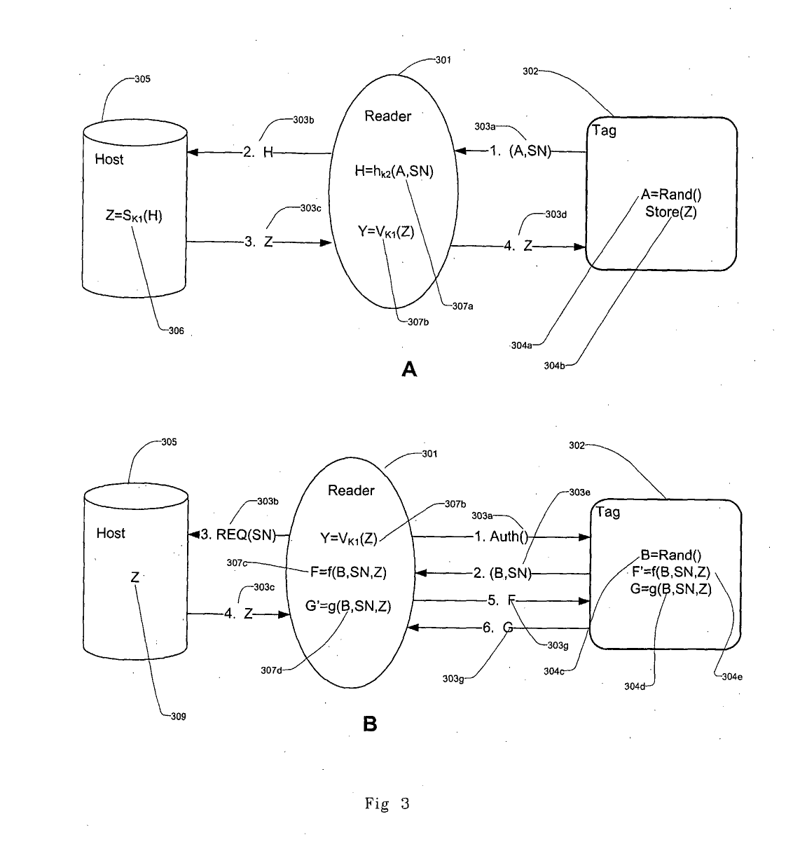

During the commissioning phase, all the parameters and all the necessary information needed for successful subsequent chip authentication is encoded into the chip memory 407. As illustrated in FIG. 3 A, during this initialization phase, the tag generates a random number A that is concatenated to the tag's serial number 404 and sent 303a as a single chunk of information to the reader 301. The reader 301 uses its private key to build 307a a hash value H on the information. This hash value is transferred 303b to the security server 305. Again it is to be noted that the expressions “security server” and “host” will be used here interchangeably.

Upon receipt of the hash value H, the host 305 uses its private key to compute 306 a digital signature Z over the hash. This digital signature is then sent 303c to the reader which uses the security server's public key to verify 307b the signed message received 303c from the security server 305. Upon successful signature verification, the signed message is sent 303d to the tag 302, which then securely stores 304b the signed message into its memory 407.

FIG. 3B illustrates normal operation that follows the initialization phase. The transaction depicted on FIG. 3B is a typical table game transaction. A reader (interrogator) 301 or a plurality thereof associated to a gaming table 107 or to a plurality thereof, initiates the transaction with a tag 302 by sending 303a an authentication request command to the tag. The tag generates 304c a random number B that is sent 303e back to the reader 305 together with the tag's serial number. Upon receipt of the random number B and the serial number 404, the reader sends 303b a retrieval command to the host 305 in order to retrieve the authentication information Z computed during the initialization phase and currently stored on the security server. Using the tag's serial number 404 the security server retrieves the digitally signed authentication information associated with the tag's serial number and returns 303c it to the interrogator. Again, using the security server's public key, the interrogator verifies 307b the signature on the authentication information Z and subsequently computes 307c a cryptographic function F over the random number B, the tag's serial number and the authentication information Z. The reader then sends 303f the result of the computation to the tag. On his side, the tag computes 304e the same function F over the random number SN, the tag's serial number and the authentication information Z. Subsequently, the tag computes another cryptographic function G over the serial number, the authentication information Z and the serial number and sends 303g the result of this computation to the reader. Upon receipt of the result of the function G the reader computes the same function G over the random number B, the tag's serial number SN and the authentication information Z. When all the computations are done, the two parts compare the result of their proper computation with those received from the communication partner. If the calculated values are equal to those received, then the interrogator and the tag have mutually authenticated each other.

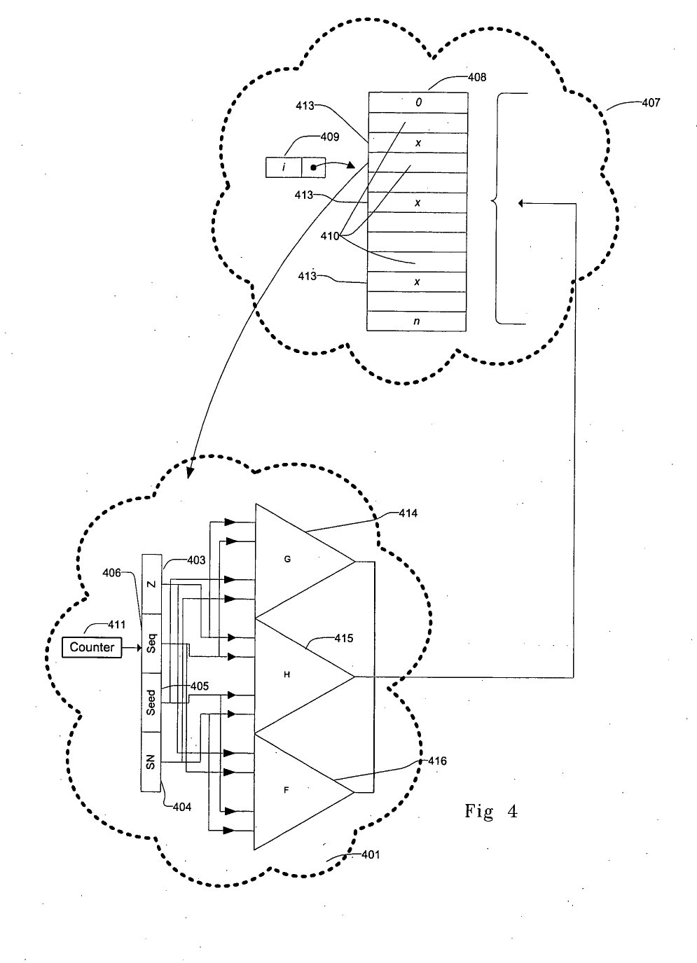

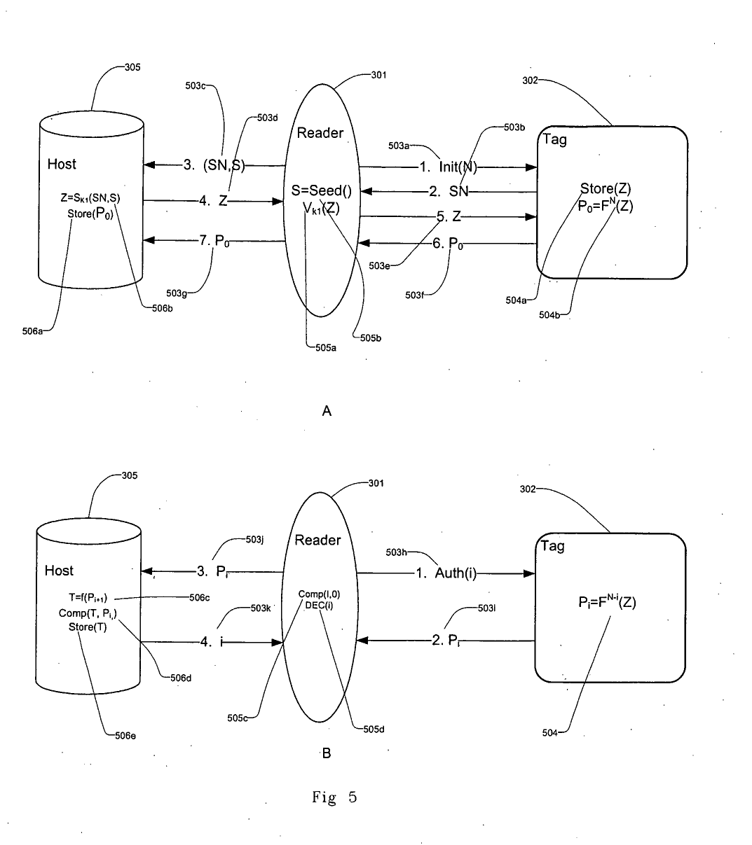

FIG. 4 depicts a preferred embodiment of the present invention where the cryptographic engine 401 of the reader and the tag's memory 407 are displayed. The memory location pointer 409, which is used to record the most recently accessed valid memory location 410, is also displayed. The usefulness of the memory location pointer will be explicitly addressed during the description of the embodiment of the present invention depicted in FIG. 5. Besides valid memory locations, the memory block 408 also displays memory locations 413 marked with an x in order to indicate that the content of these memory locations is not valid any more. The cryptographic functions F, G, H (414, 415, and 416) used throughout could be any cryptographic and persons skilled in the art will understand how to chose the best cryptographic function among those currently available or how to design other cryptographic functions that meet high security requirement. However, an embodiment of the present invention as depicted in FIG. 4 encompasses feeding 4 independent values 403, 404, 405 and 406 as input to these cryptographic functions.

FIG. 5 shows another preferred embodiment of the present invention. In this embodiment, the initialization parameter eventually defines how often the authentication process can be performed. FIG. 5A depicts the initialization process. In this process, the interrogator starts the initialization phase by sending 503a an initialization parameter to the tag. The tag responds with its serial number, which is subsequently forwarded 503c to the host by the reader along with a seed S generated by the reader. Upon receipt of the seed and the serial number, using its private key, the host generates 506b a signature Z over these two elements and subsequently sends the signature to the reader, which uses the host public key to verify 505a the signature generated by the host. Upon successful signature verification, the value Z is send 503e to the tag. The tag stores 504a the value Z. The tag then applies a cryptographic function F N times to the value Z and sends 503f P₀ the result of this operation to the reader. Without further processing, the reader forwards this value to the host, which then stores 506a P₀ in its database together with the tag's serial number SN. When a tag enters the field of the reader, the authentication sequence depicted in FIG. 5B requires that the reader first sends 503h the authentication request command along with a running index i. The tag responds to the request by applying 504 the cryptographic function F N−/times to the initial value Z. The value Pᵢ calculated this way is then sent to the host through the reader. The host then applies 506c the same function F once to the previous response of the tag and compares 506d the obtained result with the value currently received from the tag. If these two values match then the current tag's response is stored 506e in the host's database along with the tag's serial number and access is granted. The host then sends back 503k the value I to the reader. Before the next authentication, the reader compares 505c the current value of I to zero. If I is greater than zero, then the tag is allowed to attempt a new authentication and the reader decreases the value of I before sending it to the tag for a new authentication. Otherwise, if I equals to zero then the tag has reached its allowed authentication quota and must be re-commissioned.

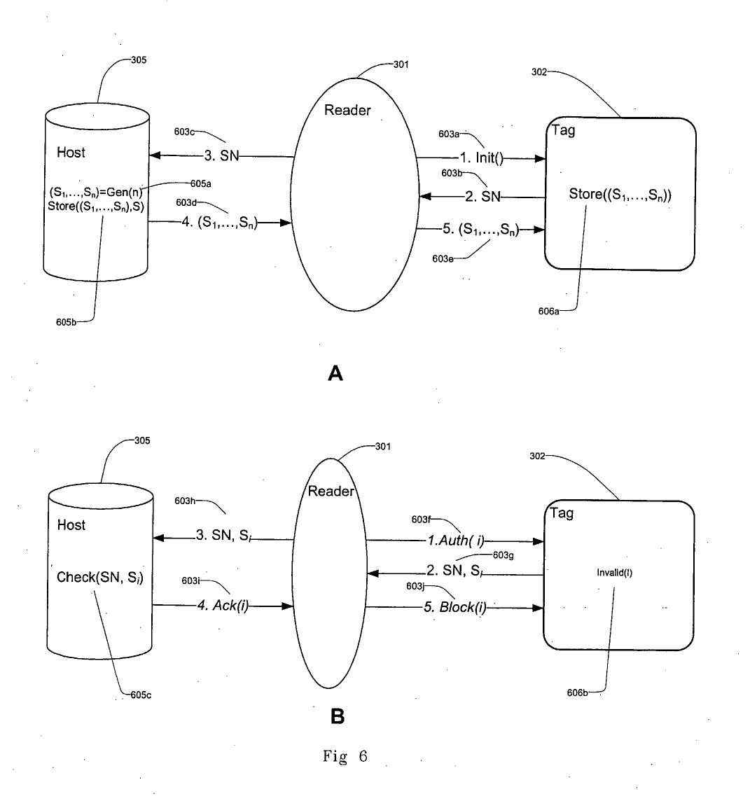

FIG. 6 depicts another embodiment of the current invention. Again, the initialization phase required for successful operation is illustrated in FIG. 6A. The initialization phase starts with the reader sending 603a an initialization command to the tag. The tag answers 603b with its serial number, which is passed to the host without any further processing. The host then generates 605a and stores 605b an n-elements set of password strings (S₁, . . . , Sₙ). These passwords are subsequently sent 603d 603e to the tag's secure memory through the reader without further processing. The host will then use the tag's serial as an index for its database.

When a tag enters the reader's field, the reader initiates an authentication process by sending 603f a random number I between 1 and n to the tag. The tag responds to this authentication request by retrieving the correct password using i as an access index 409 to valid locations 410 of one of its memory tables 408. The retrieved value is then sent 603g, 603h to the host trough the reader along with the tag's serial number. Using the tag's serial number, the host verifies that the password Sᵢ received from the tag actually corresponds to the value stored in the database at position i for that given tag. If this is the case, access is granted and the host acknowledges 603i I to the reader. Upon receipt of the acknowledgment the reader marks the value of i as invalid and informs 603j the tag that it should invalidate the memory location 413 containing the value of i. Again as with the previously discussed embodiment, when the value of i reaches n, the tag has reached the predefined authentication quota and no other authentication is possible. Using this embodiment, several chips could be authenticated simultaneously since they could all share the same value of I while their respective serial number could be used to discriminate them on the host side.

The authentication process as described in this invention and in all the preferred embodiments described herein does not restrict communication between the security server and the chips only to communication through the gaming tables or cashier station. Indeed, chips may also be interrogated and requested to authenticate at other locations within the casino. For example, the casino could be equipped with readers and magnetic couplers coils located at employee portals 103 or at the casino exits 104 in order to prevent employee or player theft.

The embodiment of the present invention are not limited to passive RIFD chip as they will work equally with battery assisted RFID devices both active and semi-passive devices comprised.

1. A system for authenticating RFID-capable gaming chips in a casino, said system comprising at least one security server, at least one secure network, a casino management system and a plurality of magnetic couplers distributed within the casino, wherein said gaming chips are adapted to provide a response to a challenge issued by said magnetic couplers when said chips are located in the vicinity of said magnetic couplers, whereby said chip is authenticated when said response matches a computed response by said server.

2. A system according to claim 1, wherein each of said gaming chips include a memory and pseudo-random number generator, and wherein each of said gaming chips has a unique serial number.

3. A system according to claim 1, wherein said challenge and said response are encrypted using symmetric cryptographic primitives.

4. A system according to claim 1, wherein said challenge and said response are encrypted using asymmetric cryptographic primitives.

5. A system according to claim 1, wherein said chips are provided with authentication information at a commissioning phase, said authentication information including a plurality of words, each word being used only once during authentication.

6. A system according to claim 1, wherein at least some of said magnetic couplers are located on or embedded in gaming tables.

7. A system according to claim 1, wherein said system further includes a commissioning station for commissioning said gaming chips when said chips first arrive at said casino, and at other predetermined times.

8. A method for authenticating RFID-capable gaming chips within a casino, comprising the steps of:
(a) commissioning said chips at a commissioning station, including loading into said chip authentication information;
(b) providing a plurality of magnetic couplers distributed in said casino;
(c) issuing a challenge from said magnetic couplers to said chips when said chips are located in the vicinity of said magnetic couplers;
(d) receiving a response from said chip;
(e) comparing said response to a computed response; and
(f) authenticating said chip when said response matches said computed response.

9. A method according to claim 8, wherein said step of providing a plurality of magnetic couplers includes the step of providing embedded active integrated circuits within the casino at gaming tables or embedded semi-passive integrated circuits or a combination thereof.

10. A method according to claim 8, wherein said response is encrypted using symmetric cryptographic primitives or asymmetric cryptographic primitives, or a combination thereof.

11. A method according to claim 8, wherein said computed response is computed in real-time.

12. A method according to claim 8, wherein said step (a) of commissioning is repeated at predetermined time intervals.

13. A method according to claim 8, wherein said authentication information is used a predefined number of time.

14. A method according to claim 8, wherein said method comprises computing and storing the authentication information in the gaming chip before the first authentication.

15. A method according to claim 8, wherein said method comprises computing the authentication on the fly during the authentication process.

16. A method for authenticating an RFID reader to a gaming chip within the casino comprising:
the gaming chip issuing a challenge to the RFID reader;
the gaming chip receiving a response from the RFID reader;
comparing said response to a computed response; and
authenticating the reader when said response matches said computed response.

17. A method of gaming chip authentication in accordance with claim 8 wherein the challenge value is pseudo-random value.

18. A method of gaming chip authentication in accordance with claim 8 wherein the challenge value is a binary string.
